(19) United States
(12) Patent Application Publication
(10) Pub. No.: US 2025/0176586 A1
(43) Pub. Date: Jun. 5, 2025

(54) MACHINE FOR PROCESSING AND STORING LIQUID OR SEMI-LIQUID FOOD PRODUCTS

(71) Applicant: ALI GROUP S.R.L. - CARPIGIANI, Cernusco Sul Naviglio (MI) (IT)

(72) Inventors: Roberto LAZZARINI, Reggio Emilia (RE) (IT); Federico TASSI, Bologna (IT)

(21) Appl. No.: 18/965,685

(22) Filed: Dec. 2, 2024

(30) Foreign Application Priority Data
Dec. 5, 2023 (IT) 102023000026025

(51) Int. Cl. A23G 9/22; A23G 9/10; A23G 9/12

(52) U.S. Cl. CPC A23G 9/228; A23G 9/106; A23G 9/12; A23G 9/224

(57) ABSTRACT

A machine for processing and preserving liquid or semi-liquid food products, includes: a frame having an upper surface; a container for the product with an internal stirrer, the upper surface having an opening to the container; an actuator rotates the stirrer relative to the container or vice-versa; a refrigeration system, including: a closed circuit to circulate a heat transfer fluid, an evaporator, associated with the container, a compressor, a condenser, and a lamination member; a cover movable between a closed position for access to the container via the opening, and an open position, allowing access to the container, the cover defining in the closed position a volume between an internal surface of the cover and the upper surface; an air suction system within the volume including a suction unit and a suction mouth in fluid communication with the volume; a control unit controls the actuator and the suction unit.

This application claims priority to Italian Patent Application 102023000026025 filed Dec. 5, 2023, the entirety of which is incorporated by reference herein.

This invention relates to a machine for processing and storing liquid or semi-liquid food products, in particular a machine for making and then storing such products inside the selfsame machine.

This invention relates in particular to a machine which is capable of performing a batch freezing process.

The batch freezing process is generally very quick and little affected by the ambient conditions.

Static storage of the batch frozen product, on the other hand, is greatly dependent, for example, on external temperature, external temperature variations and ambient relative humidity.

In effect, ambient conditions have an influence on the storage life of batch frozen products such as ice cream, for example.

In particular, relative humidity—that is, the measure of the amount of water vapour in the air relative to the maximum amount of water vapour which the air could contain at a given temperature-affects the storage life of the ice cream predominantly through the phenomenon of ice formation on the surface of the ice cream itself.

When relative humidity is high, there is a large amount of water vapour carrying more air molecules onto the surface of the ice cream, where it cools and condenses.

This change of phase releases heat which further melts the ice cream. In dry air, there is practically no condensate and the ice cream melts much more slowly.

Known in the prior art are machines which are capable of correcting this phenomenon, thus minimizing its effect and lowering the temperature on the surface of the ice cream.

As a result, however, mixture, condensation and humidity freeze and form thin layers of ice on the surface of the product.

The ice thus formed may alter the consistency and organoleptic properties of the ice cream.

The ambient temperature is also a critical factor for the storage of ice cream, since excessive temperature variations may lead to melting followed by refreezing of the product, thus further altering its consistency and structure.

Generally speaking, the optimum conditions for storing ice cream are constant low temperature and moderate relative humidity to prevent ice from forming and settling on the surface of the food product which, therefore, tends to better keep its freshness, that is, its original consistency and flavour.

The aim of this invention is to provide a machine for processing and storing liquid or semi-liquid food products and which is capable of ensuring that the product is stored under optimal conditions.

In particular, the aim of this invention is to provide a machine for processing and storing liquid or semi-liquid food products and which is capable of preventing, or at least minimizing the formation and settling of ice on the surface of the product being processed and to be stored.

The technical features of the invention, with reference to the above aims, are clearly described in the claims below and its advantages are apparent from the detailed description which follows, with reference to the accompanying drawings which illustrate an exemplary, hence non-limiting embodiment of the invention, and in which:

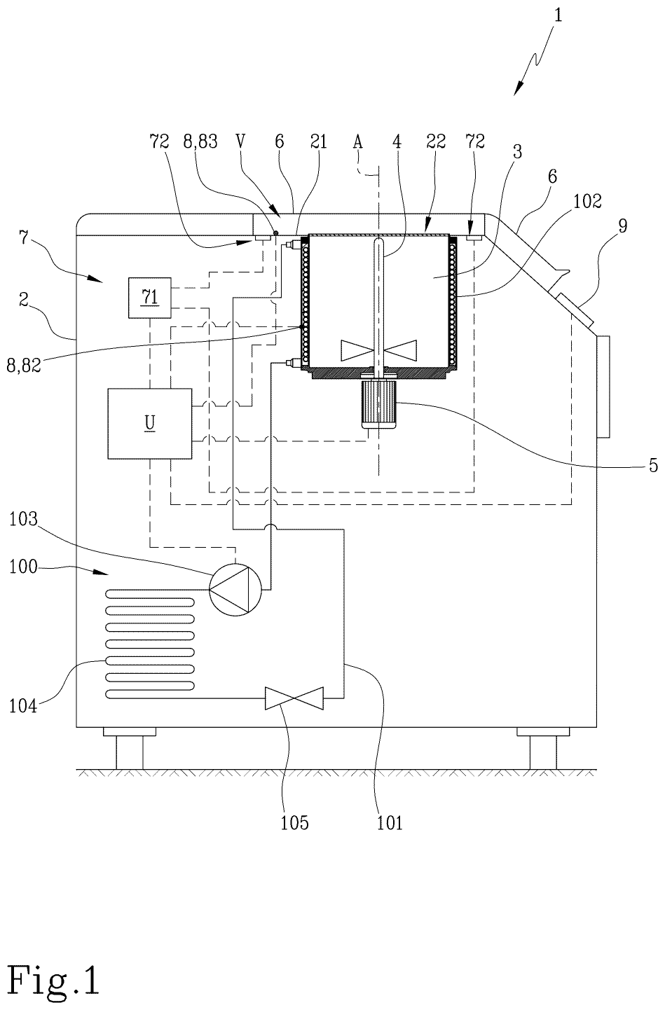

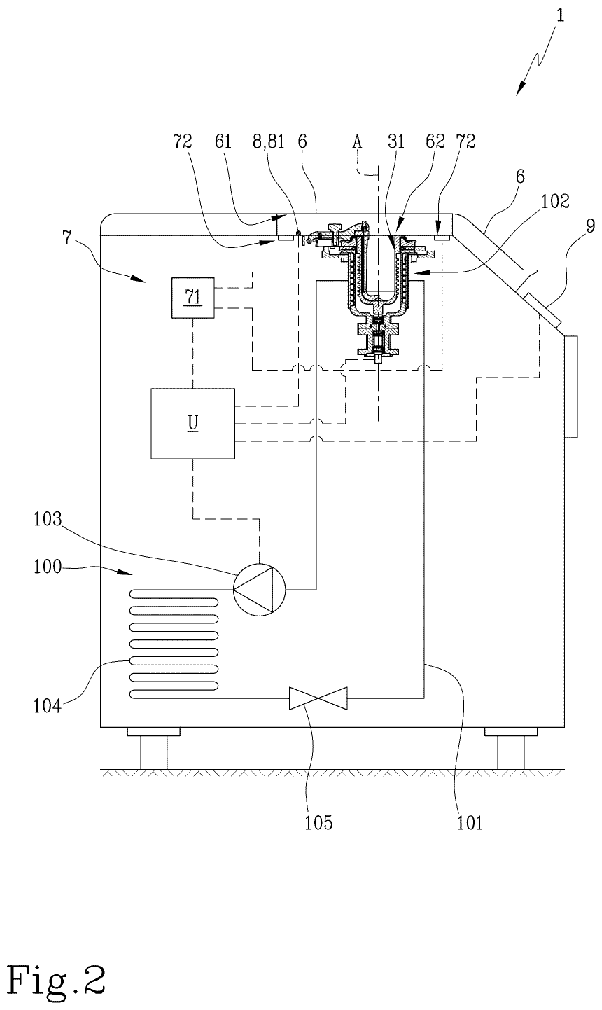

FIGS. 1 and 2 show cross-sectional side views of embodiments of a machine according to this disclosure;

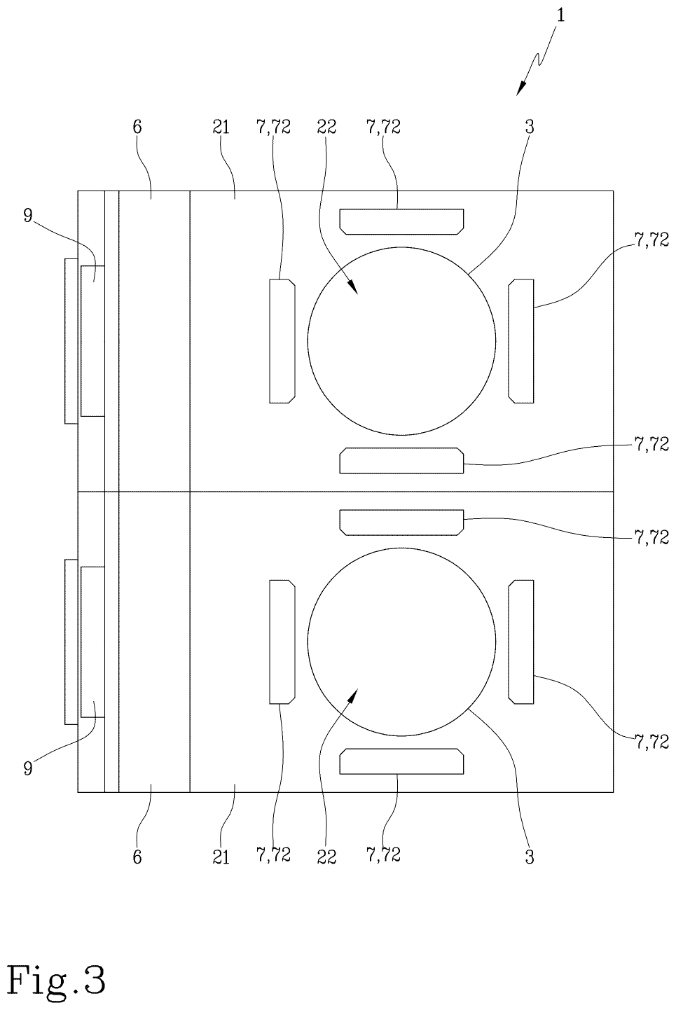

FIG. 3 shows a top cross-sectional view of a machine according to this disclosure.

With reference to the accompanying drawings, the numeral 1 denotes a machine for processing and storing liquid or semi-liquid food products according to this invention.

The machine 1 may allow the production of different types of liquid or semi-liquid products, such as, for example, ice creams, sorbets, yogurts, custards.

According to the invention, the machine 1 comprises a main frame 2 having at least a top surface 21.

The machine 1 comprises at least one container 3 for containing the product to be processed and stored.

In use, the container 3 is located inside a space defined by the main frame 2.

The top surface 21 of the machine 1 having at least one opening 22 giving access to the container 3.

In other words, the main frame 2 has, on its top surface 21, the access opening 22 through which the container 3 can be accessed.

Advantageously, accessing the container 3 allows placing the product to be processed by the machine 1 into the container 3 and/or taking the processed, stored product out of the container 3.

According to the invention, the machine 1 comprises a stirrer 4 mounted inside the container 3.

According to the invention, the machine 1 comprises an actuator 5 connected to the stirrer 4 or to the container 3 to drive the stirrer 4 relative to the container 3 or the container 3 relative to the stirrer 4, respectively, in rotation about a mixing axis A.

The machine 1 comprises a control unit U configured to control at least the actuator 5.

The machine 1 comprises a refrigeration system 100, comprising: a closed circuit 101 configured to circulate a heat exchanger fluid, an evaporator 102 associated with the container 3, a compressor 103, a condenser 104 and a throttle element 105.

The heat exchanger fluid in the closed circuit 101 flows through the following: the evaporator 102, the compressor 103, the condenser 104 and the throttle element 105, in that order.

The evaporator 102, in a preferred embodiment, is operatively coupled to the container 3, thus allowing heat to be exchanged between the heat exchanger fluid and the product being processed inside the container 3.

In an embodiment, the evaporator 102 and the container 3 have a partition wall in common. In particular, the partition wall has a surface in contact with the heat exchanger fluid and a further surface in contact with the product to be dispensed.

The container 3 is provided with walls having an inside surface 31 and, in this configuration, the walls of the container 3, because they are the closest to the evaporator 102, are subject to possible ice formation.

The evaporator 102 is preferably a coil wound around the container 3.

Preferably, the stirrer 4 is provided with blades which are adapted to prevent ice buildup on the inside surface 31 of the container 3; in effect, the blades are adapted to scrape the inside surface 31 of the container 3 as the stirrer 4 rotates.

In an embodiment in which the actuator 5 is connected to the container 3 to drive the container 3 relative to the stirrer 4 in rotation about the mixing axis A, as illustrated schematically in FIG. 2, the machine 1 has a compartment, where the container 3 is mounted, which can be filled with a secondary heat exchanger fluid.

The secondary fluid is preferably glycol.

The evaporator 102 is in contact with the outside walls of the compartment to exchange heat with the secondary heat exchanger fluid which, as it permeates the compartment, exchanges heat with the container 3, hence with the product contained therein.

Advantageously, this solution allows optimum heat exchange between evaporator 102 and product and, at the same time, allows the container 3 to rotate relative to the stirrer 4.

According to the invention, the machine 1 comprises a cover 6 movable between a closed position, where it closes said opening 22 to deny access to the container 3, and an open position, where it opens said opening 22 to give access to the container 3.

Advantageously, at the closed position, the cover 6 allows protecting the product, in particular the product being stored, against external agents or dust from the outside.

Advantageously, at the closed position, the cover 6 allows limiting heat exchange between the inside of the container 3, hence the product, and the exterior environment.

In an embodiment, the cover 6 is made of a transparent material.

In an embodiment, the cover 6 comprises a closing portion 62 for closing the opening 21 which gives access to the container 3.

Preferably, the machine 1 comprises a gasket located between the inside surface 31 of the container 3 and the closing portion of the cover 6.

According to an aspect, the closing portion 62 is configured to be inserted at least partly into the container 3 when the cover is at the closed position.

The cover 6, at the closed position, defines a space V between an inside surface 61 of the cover 6 and the top surface 21 of the main frame 2.

It should be noted that the space V is permeated with air in direct contact with the container 3, with the inside surface 31 of the container 3 and with the surface of the product inside the container 3.

According to the invention, the machine 1 comprises a suction system 7 for extracting air from the space V.

It should be noted that extracting air from the space V enables the ambient conditions of the product being processed and stored to be varied and controlled.

The expression “ambient conditions” is used to mean aspects which are exterior to the product and which may directly or indirectly affect its quality such as, by way of non-limiting example, the temperature of the surfaces in contact with the product, the temperature of the air in contact with the product or the relative humidity of the surrounding air.

The suction system 7 comprises at least one suction unit 71 and one or more suction mouths 72 connected to the suction unit 71.

Each suction mouth 72 is in fluid communication with the space V to extract air from the interior of the space V.

Advantageously, extracting air from the space V allows minimizing the amount of water vapour inside the space. Consequently, it allows minimizing the water vapour phase transitions in contact with the surface of the ice cream.

Advantageously, extracting air from the space V thus allows preventing the formation of thin layers of ice on the surface of the product.

Advantageously, extracting air from the space allows conditioning the temperature inside the space V.

Advantageously, controlling the quantity of water vapour and the temperature inside the space V allows ensuring optimum conditions for product storage.

According to the invention, the control unit U is configured to control the suction unit 71.

In other words, the control unit U is configured to turn the suction unit 71 on and off.

In an embodiment, the suction unit 71 is a pump, configured to extract air.

According to an aspect of this disclosure, one or more suction mouths 72 are located at a respective portion of the top surface 22 of the main frame 2.

According to an aspect of this disclosure, one or more suction mouths 72 are located at a respective portion of the cover 6.

It should be noted that the suction mouths 72 may differ in shape and size.

The suction mouths 72 are preferably connected to the suction unit 71 by ducts which are illustrated only schematically in the accompanying drawings.

In the embodiment in which the suction mouths 72 are located at a respective portion of the cover 6, the ducts which connect the suction unit 71 to the suction mouths 72 may comprise at least one portion located outside the space defined by the main frame 2.

In an embodiment, the machine 1 may comprise a plurality of suction units 71 and the suction mouths 72 are connected to one or more suction units 71.

In a preferred embodiment, the machine 1 comprises at least one sensor 8 configured to detect a parameter defining an ambient condition of the product to be processed.

The sensor 8 is connected to the control unit U to send it a signal relating to the aforesaid parameter defining an ambient condition of the product to be processed.

The control unit U is configured to control the suction unit 71 as a function of said signal.

In other words, the control unit U turns the suction unit 71 on or off as a function of the signal sent by the sensor 8 and representing an ambient condition of the product.

Advantageously, controlling the extraction of air from the space V as a function of this signal allows controlling in real time the ambient conditions of the product being processed and/or stored, such as, for example, temperature and relative humidity of the air.

Advantageously, controlling the ambient conditions in real time allows ensuring the optimum product storage conditions.

According to an aspect of this disclosure, at least one sensor 8 is an air temperature sensor 81.

The air temperature sensor 81 is located inside the space V defined between the inside surface 61 of the cover 6 and the top surface 22 of the main frame 2 to detect a temperature of the air inside the space V.

Advantageously, the control unit U is configured to control the suction unit 71 as a function of the signal representing the temperature of the air inside the space V.

According to an aspect of this disclosure, at least one sensor 8 is a temperature sensor 82 for the heat exchanger fluid, located in the evaporator 102, for detecting a temperature of the heat exchanger fluid.

Advantageously, the control unit U is configured to control the suction unit 71 as a function of the signal representing the temperature of the heat exchanger fluid.

According to an aspect of this disclosure, at least one sensor 8 is a hygrometer 83, located inside the space V defined between the inside surface 61 of the cover 6 and the top surface 22 of the main frame 2, to detect a value of the relative humidity inside the space V.

Advantageously, the control unit U is configured to control the suction unit 71 as a function of the signal representing the value of the relative humidity inside the space V.

Preferably, the machine 1 comprises a user interface 9 which is connected to the control unit U.

The user interface 9 comprises at least one user operable control.

The user interface 9 preferably comprises a plurality of user operable controls.

Preferably, the user interface 9 comprises user-operable activation and selection controls and/or pushbuttons.

Advantageously, the user interface 9 allows displaying information, even in real time, relating to the machine 1 and/or to the product being processed, such as, for example, the temperature of the air inside the space V, the temperature of the heat exchanger fluid, and the value of the relative humidity inside the space V.

Preferably, the control unit U is connected to the compressor 103 and/or to the throttle element 105 to regulate the flow of the heat exchanger fluid in the closed circuit 101.

Advantageously, together with the control unit U, the user interface 9 can be used to control several aspects of the machine 1 such as, for example, the flow of heat exchanger fluid in the closed circuit 101 through the compressor 103 and/or the throttle element 105, the mutual rotational movement between the stirrer 4 and the container 3, extraction of air from the space V through the suction unit 71.

In an embodiment, the machine 1 comprises a plurality of containers 3 and a cover 6 for each of the containers 3 of the plurality of containers 3.

It should be noted that in such an embodiment, there is a plurality of spaces V, one for each cover 6 and respective container 3, and the machine comprises suctions mouths 72, connected to one or more suction units 71, in fluid communication with the spaces V to extract air from the interior of each of the spaces V.

1. A machine for processing and storing liquid or semi-liquid food products, comprising:
a main frame having at least a top surface;
at least one container for containing the product to be processed and stored, the top surface of the machine having at least one opening giving access to the container;
a stirrer mounted inside the container;
an actuator connected to the stirrer or to the container to drive the stirrer relative to the container or the container relative to the stirrer, respectively, in rotation about a mixing axis;
a refrigeration system, comprising: a closed circuit configured to circulate a heat exchanger fluid, an evaporator associated with the container, a compressor, a condenser and a throttle element, said heat exchanger fluid flowing along the closed circuit through the following, in succession: the evaporator, the compressor, the condenser and the throttle element, in that order;
a cover movable between a closed position, where it closes said opening to deny access to the container, and an open position, where it opens said opening to give access to the container, the cover defining, at the closed position, a space between an inside surface of the cover and the top surface of the main frame;
a suction system for extracting air from said space, comprising at least one suction unit and one or more suction mouths connected to the suction unit, each suction mouth being in fluid communication with said space;
a control unit configured to control at least the actuator and the suction unit.

2. The machine according to claim 1, comprising at least one sensor, configured for detecting a parameter defining an ambient condition of the product to be processed, the sensor being connected to the control unit to send it a signal relating to said parameter defining an ambient condition of the product to be processed, the control unit being configured for controlling the suction unit as a function of said signal.

3. The machine according to claim 2, wherein at least one sensor is an air temperature sensor, located inside said space defined between the inside surface of the cover and the top surface of the main frame, to detect a temperature of the air inside said space.

4. The machine according to claim 2, wherein at least one sensor is a temperature sensor for the heat exchanger fluid, located in the evaporator, for detecting a temperature of the heat exchanger fluid.

5. The machine according to claim 2, wherein at least one sensor is a hygrometer, located inside said space defined between the inside surface of the cover and the top surface of the main frame, to detect a value of the relative humidity inside said space.

6. The machine according to claim 5, wherein one or more suction mouths are located at a respective portion of the top surface of the main frame.

7. The machine according to claim 1, wherein one or more suction mouths are located at a portion of the cover.

8. The machine according to claim 1, wherein the suction unit is a pump configured for extracting air.

9. The machine according to claim 1, wherein the cover comprises a closing portion for closing the opening which gives access to the container.

10. The machine according to claim 9, wherein the container has walls with an inside surface, the machine comprising a gasket located between the inside surface of the container and the closing portion of the cover.

11. The machine according to claim 1, wherein the container is made from transparent material.

12. The machine according to claim 1, comprising a plurality of containers and a cover for each of the containers of the plurality of containers.

13. The machine according to claim 1, comprising a user interface connected to the control unit and comprising at least one user activable control.
